(19) United States
(12) Patent Application Publication
(10) Pub. No.: US 2014/0166855 A1
(43) Pub. Date: Jun. 19, 2014

(54) IMAGE ACQUISITION APPARATUS AND MICROSCOPE SYSTEM

(71) Applicant: OLYMPUS CORPORATION, Tokyo (JP)

(72) Inventor: Hiroshi FUJIKI, Tokyo (JP)

(73) Assignee: OLYMPUS CORPORATION, Tokyo (JP)

(21) Appl. No.: 14/079,724

(22) Filed: Nov. 14, 2013

(30) Foreign Application Priority Data
Dec. 13, 2012 (JP) 2012-272306

(51) Int. Cl. H04N 3/14; H04N 5/378

(52) U.S. Cl. CPC H04N 3/1556; H04N 5/378
USPC 250/208.1

(57) ABSTRACT

This image acquisition apparatus is provided with an imaging device that can output acquired image signals from a plurality of output portions; a timing generator that drives the output portions of the imaging device; and a system control portion that acquires observation conditions, wherein, based on the observation conditions acquired by the system control portion, the timing generator switches between parallel outputting of the image signals from the plurality of output portions of the imaging device and single outputting of the image signal from any one of the output portions.

### CROSS-REFERENCE TO RELATED APPLICATIONS

This application is based on Japanese Patent Application No. 2012-272306, the content of which is incorporated herein by reference.

### TECHNICAL FIELD

The present invention relates to an image acquisition apparatus and a microscope system.

### BACKGROUND ART

In the related art, there is a known technique in which an imaging device that can sequentially read out signal charges from a plurality of channels is provided, differences in signal levels among the signals output from the individual channels are corrected, and thus, level differences formed in an image are reduced (for example, see Patent Literatures 1-3).

### CITATION LIST

### Patent Literature

{PTL 1} Japanese Unexamined Patent Application, Publication No. 2008-301173
{PTL 2} Japanese Unexamined Patent Application, Publication No. 2004-146897
{PTL 3} Japanese Unexamined Patent Application, Publication No. 2002-320142

### SUMMARY OF INVENTION

### Technical Problem

With regard to signals output from the plurality of channels, there are various causes of the differences among signals from the respective channels, which includes performance variability of read-out amplifiers in an imaging device, temperature variability, variability of peripheral circuits such as AFEs, and the like.

The present invention provides an image acquisition apparatus and a microscope system with which a high-quality image can be obtained by preventing level differences from occurring in an image when there are differences among signals output from a plurality of channels, and with which an image can be obtained at a high frame rate when there is no or little difference among the signals.

### Solution to Problem

An aspect of the present invention provides an image acquisition apparatus including an imaging device that can output acquired image signals from a plurality of output portions, a timing generator that drives the output portions of the imaging device, and a condition acquisition portion that acquires observation conditions, wherein, the timing generator is configured to switch between parallel outputting of the image signals from the plurality of output portions of the imaging device and single outputting of the image signal from any one of the output portions based on the observation conditions acquired by the condition acquisition portion.

### BRIEF DESCRIPTION OF DRAWINGS

FIG. 1 is a diagram showing a schematic configuration of a microscope system provided with an image acquisition apparatus according to an embodiment of the present invention.

FIG. 2 is a schematic view showing the image acquisition apparatus in FIG. 1.

FIG. 3 is a flowchart for explaining image acquisition control performed by a system control portion of the image acquisition apparatus in FIG. 1.

FIG. 4 is a diagram showing program lines for calculation of exposure time and digital gain, which are performed by the system control portion in FIG. 3.

FIG. 5 is a diagram showing a schematic configuration of a modification of the microscope system described in FIG. 1.

FIG. 6 is a flowchart for explaining an example of image acquisition control performed by the system control portion described in FIG. 5.

FIG. 7 is a flowchart for explaining another example of image acquisition control performed by the system control portion described in FIG. 5.

### DESCRIPTION OF EMBODIMENT

An image acquisition apparatus 1 according to an embodiment of the present invention will be described below with reference to the drawings.

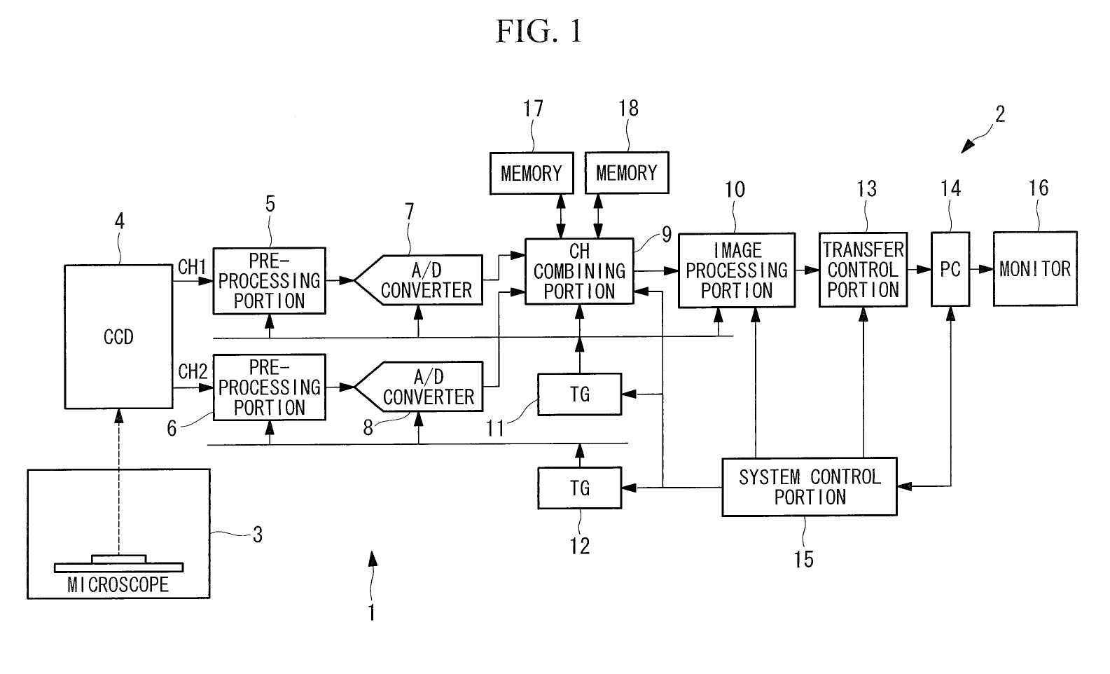

As shown in FIG. 1, the image acquisition apparatus 1 according to this embodiment is an image acquisition apparatus 1 provided in a microscope system 2 and is provided with the following elements: an imaging device 4, such as a CCD, that can output image signals from two channels by detecting an optical image of a specimen acquired by a microscope main unit 3; pre-processing portions 5 and 6 that receive output currents from the respective channels of the imaging device 4 as inputs and that apply CDS, amplification, and object clamping processing thereto; and A/D converters 7 and 8 that convert the outputs from the pre-processing portions 5 and 6 to digital signals.

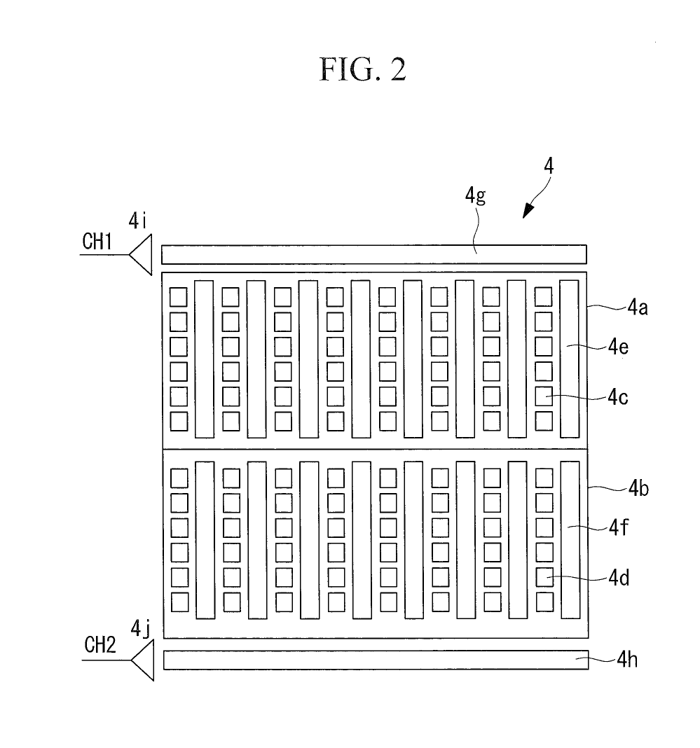

As shown in FIG. 2, the imaging device 4 is provided with, for example, a plurality of photodiodes 4c and 4d arranged in image acquisition regions 4a and 4b, vertical transfer paths 4e and 4f, and horizontal transfer paths 4g and 4h. Charges accumulated in the photodiodes 4c in the image acquisition region 4a are transferred to the vertical transfer paths 4e, and are output from an amplifier 4i via the horizontal transfer path 4g. Charges accumulated in the photodiodes 4d in the image acquisition region 4b are transferred to the vertical transfer paths 4f, and are output from an amplifier 4j via the horizontal transfer path 4h. By doing so, the signal charges can be read out from the two channels at the same time.

In addition, the image acquisition apparatus 1 is provided with the follwing elements: a channel combining portion 9 that converts the image signals from the two channels that have been converted to digital signals into a one-channel image-acquisition signal by combining them; an image processing portion 10 that applies white-balance processing, black-balance processing, demosaicing processing, and edge enhancement processing to the combined image-acquisition signal; and timing generators 11 and 12. In the figure, reference signs 17 and 18 indicate memories that temporarily store the image-acquisition signals transmitted thereto from the A/D converters 7 and 8.

The timing generators 11 and 12 supply the pre-processing portions 5 and 6, the A/D converters 7 and 8, the channel combining portion 9, and the image processing portion 10 with vertically synchronizing signals and horizontally synchronizing signals, and supply the channels of the imaging device 4 with pulses for reading out the signal charges.

Regarding the pre-processing portions 5 and 6, the A/D converters 7 and 8, and the timing generators 11 and 12, one of each is provided in the respective channels of the imaging device 4.

In the example shown in FIG. 1, the imaging device 4 has two-channel outputs. In this example, based on the pulses from the timing generators 11 and 12, signal-charge readout from the imaging device 4, processing by the pre-processing portions 5 and 6, and conversion processing by the A/D converters 7 and 8 are performed in parallel at the same time for the respective channels, and the signals therefrom are combined by the channel combining portion 9. Accordingly, in this example, the signal charges can be read out twice as fast.

In addition, the image acquisition apparatus 1 is provided with a transfer control portion 13 that transfers the digital image signals from the image processing portion 10 to a data bus.

In addition, the image acquisition apparatus 1 is provided with a computer 14 that executes a control program stored in a storage unit (not shown). The computer 14 outputs commands for setting image acquisition conditions such as framing, still image acquisition, exposure time, ISO sensitivity, and so forth, which are commands from the control program, to a system control portion 15, and the computer 14 also displays the digital image signals input from the transfer control portion 13 on a monitor 16.

The system control portion (condition acquisition portion) 15 interprets the commands from the control program, thus controlling the exposure in the imaging device 4 and signal-charge readout from the imaging device 4, and also setting image processing parameters in the image processing portion 10.

Specifically, the system control portion 15 supplies settings for the drive patterns of the imaging device 4 to the pre-processing portions 5 and 6, the A/D converters 7 and 8, the timing generators 11 and 12, and the channel combining portion 9 via the data bus, thereby controlling the exposure in the imaging device 4 and the signal-charge readout. Furthermore, the system control portion 15 interprets the commands for setting the image acquisition conditions, such as framing, still image acquisition, exposure time, ISO sensitivity, and so forth, which are commands from the computer 14, thus generating appropriate image processing parameters for the image acquisition conditions. In addition, the system control portion 15 supplies the generated image processing parameters to the image processing portion 10 via the data bus.

The operation of the thus-configured image acquisition apparatus 1 according to this embodiment will be described below.

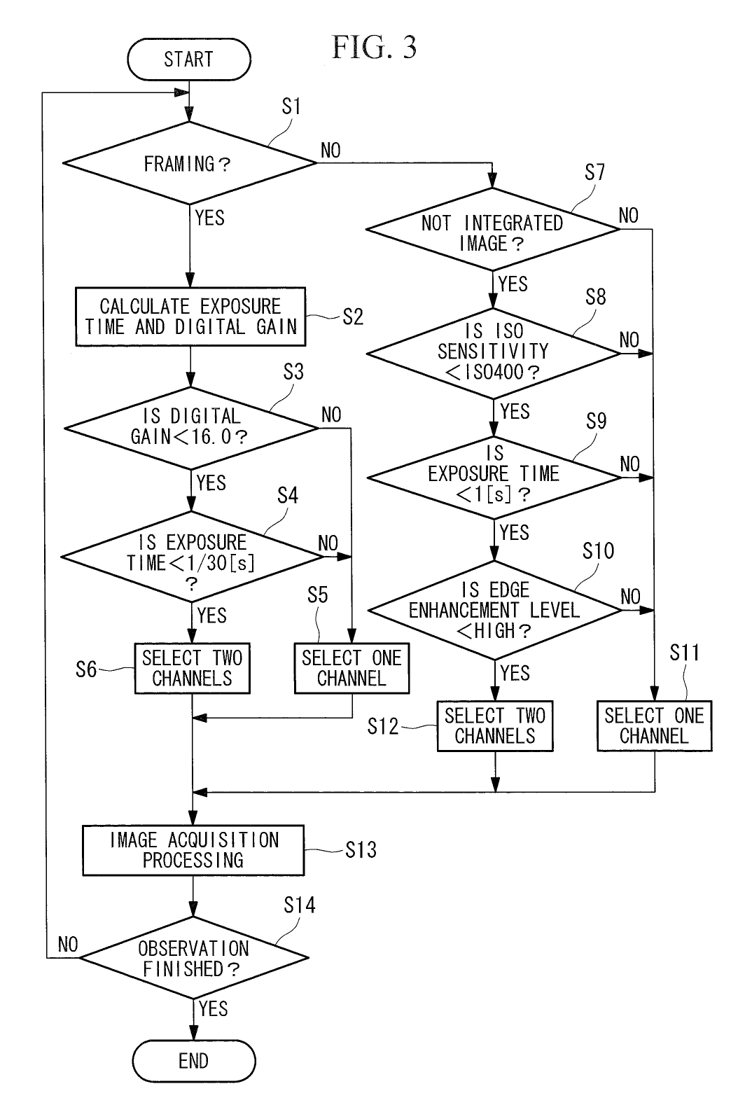

A case in which an image of a specimen is captured by using the image acquisition apparatus 1 according to this embodiment will be described below. As shown in FIG. 3, first, the system control portion 15 judges whether or not framing is set for consecutively acquiring the digital image signals (Step S1), and, in the case of such framing, the system control portion 15 calculates the exposure time and digital gain (Step S2).

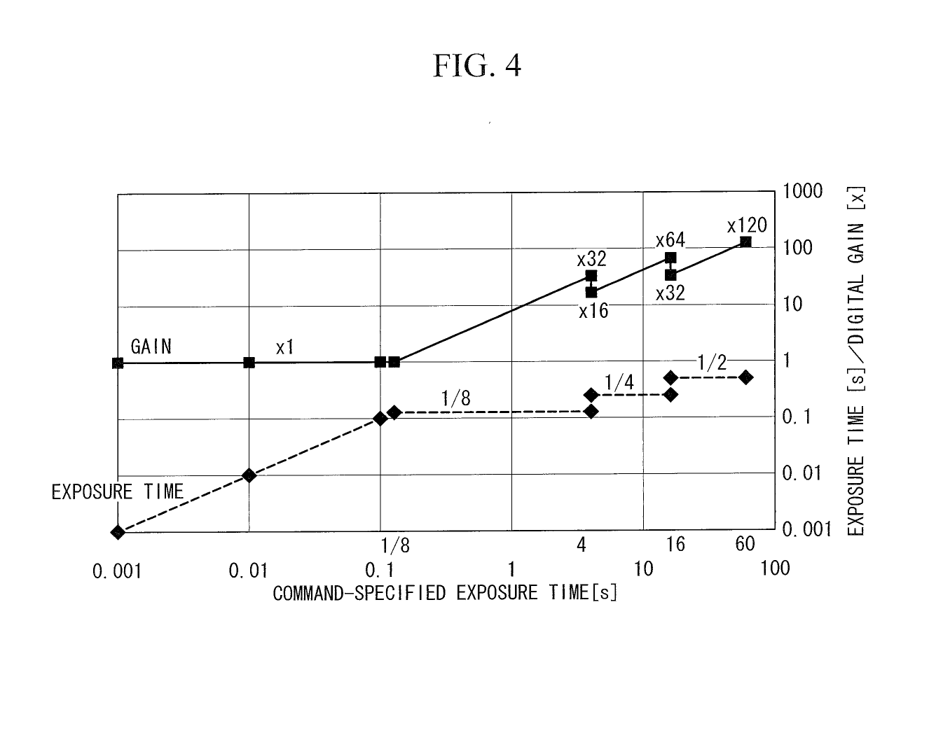

FIG. 4 shows a diagram showing example program lines for calculating the exposure time and digital gain for the imaging device 4. The system control portion 15 calculates the exposure time and digital gain of the imaging device 4 in accordance with the program lines in FIG. 4 based on the exposure time specified by the commands.

Next, the system control portion 15 judges whether or not the calculated digital gain is equal to or greater than a predetermined threshold, for example, 16.0 (Step S3). If the digital gain is equal to or greater than the threshold, the system control portion 15 selects forming an image based on the output signal from one of the channels (Step S5), and, if it is less than the threshold, the system control portion 15 judges whether or not the calculated exposure time of the imaging device 4 is equal to or greater than a predetermined threshold, for example, 1/30 s (Step S4).

If the calculated exposure time of the imaging device 4 is equal to or greater than the threshold, the system control portion 15 selects forming an image based on the output from one of the channels (Step S5), and, if it is less than the threshold, the system control portion 15 selects forming an image based on the output signals that are output in parallel from the two channels (Step S6).

On the other hand, when it is judged in Step S1 that the framing is not set as described above, the system control portion 15 refers to the image acquisition conditions. With regard to the image acquisition conditions, it is judged whether or not to perform integrated image acquisition (Step S7), which makes it possible to achieve exposure that exceeds the maximum exposure time of a microscope by acquiring still images multiple times and adding them with each other by means of image processing, and it is also judged whether or not image acquisition parameters such as ISO sensitivity, exposure time, edge enhancement level, and so forth are equal to or greater than predetermined thresholds (Steps S8, S9, and S10).

In the case in which the integrated image acquisition is performed, if the respective image acquisition parameters, including ISO sensitivity, exposure time, edge enhancement level, and so forth are equal to or greater than the respective thresholds, for example, when the image acquisition parameters are equal to or greater than ISO400, an exposure time of 1 s, and a “high” edge enhancement level, the system control portion 15 selects forming an image based on the output signal from a single channel (Step S11). In the cases other than the above-described case, the system control portion 15 selects forming an image based on the output signals that are output in parallel from the two channels (Step S12).

Then, based on the selection results in Steps S5, S6, S11, and S12, the system control portion 15 instructs the channel combining portion 9 to combine the output signals from one channel or two channels, thus performing image acquisition processing (Step S13). Subsequently, it is judged whether or not to end observation (Step S14), and the steps from Step S1 are repeated if the observation is to be continued.

In this way, with the image acquisition apparatus 1 according to this embodiment, it is possible to switch between image acquisition based on one channel and image acquisition based on two channels in accordance with image acquisition conditions and the observation conditions, such as image acquisition parameters. As a result, for example, when the exposure time is short, because it can be determined that the light level is high from the beginning, an image can be acquired at a high frame rate by outputting the image signals in parallel from the two channels. On the other hand, when the exposure time is long, by forming an image based only on the output signal from a single channel, thus eliminating image combining, a high-quality image can be acquired by preventing level differences from occurring between the channels.

In addition, in this embodiment, image acquisition is switched between image acquisition based on one channel and image acquisition based on two channels in accordance with the image acquisition conditions, such as image integration, ISO sensitivity, digital gain, or edge enhancement level. Accordingly, when it is not possible to completely correct the differences in the image signal levels between the channels or when the difference would be amplified, a high-quality image can be acquired by performing image acquisition based only on the output signal from the single channel.

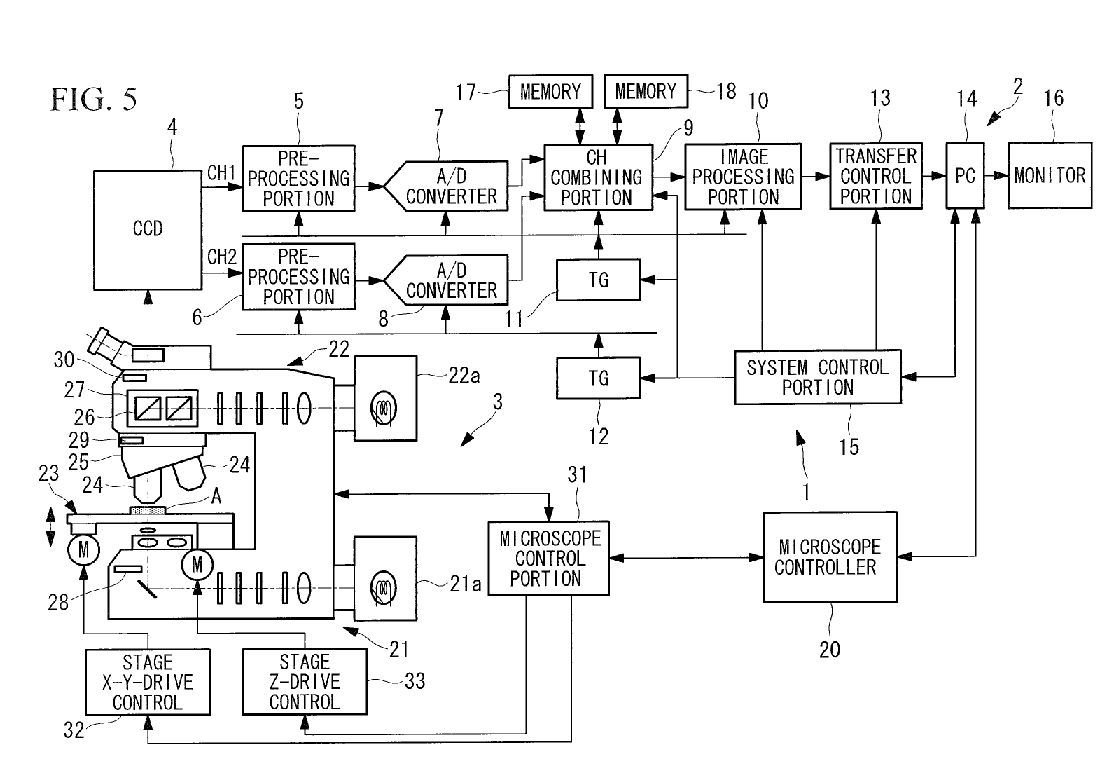

Note that, in this embodiment, the image acquisition apparatus 1 changes the number of channels to be used in accordance with the image acquisition conditions. Alternatively, as shown in FIG. 5, settings (observation conditions) from the microscope main unit 3 may be received and the number of channels to be used in the image acquisition apparatus 1 may be changed in accordance with those settings.

In the example shown in FIG. 5, the microscope system 2 is provided with the microscope main unit 3, a microscope controller 20, and the image acquisition apparatus 1 described above.

The microscope main unit 3 is provided with, for example, a transmission observation optical system 21 and an epi-illumination observation optical system 22. In addition, the microscope main unit 3 is provided with an electric moving stage 23 on which a specimen A is placed, a revolver 25 that switches among objective lenses 24, a cube turret 27 that switches among fluorescence cubes 26, a differential-interference-observation polarizer 28 that can be placed in and removed from an optical path, a DIC prism 29, and an analyzer 30.

These individual components are electrically powered and are controlled by a microscope control portion 31 described below.

The microscope control portion 31 is connected to the microscope controller 20, changes the microscopy method in accordance with control signals or commands from the microscope controller 20, and adjusts the light levels from a transmission illumination light source 21a and an epi-illumination light source 22a. In addition, the microscope control portion 31 transmits the current microscopy conditions of the microscope main unit 3 to the microscope controller 20. Additionally, the microscope control portion 31 is also connected to a stage X-Y-drive control portion 32 and a stage Z-drive control portion 33, and outputs the conditions thereof to the microscope controller 20.

The microscope controller 20 is a controller having a touch screen for a user to make inputs for operating the microscope main unit 3, and is connected to the computer 14 via the data bus.

When the user selects a microscopy method via the touch screen, the microscope controller 20 transmits a command to the microscope control portion 31 to report the microscopy method to be used. The microscope control portion 31 selects an appropriate optical device for the selected microscopy method and determines the optical device conditions.

Subsequently, when the user performs operations via the touch screen indicating starting of framing, stopping of framing, capturing of a still image, selection of the high-quality mode, and so forth, settings for the high-quality mode or settings for the high-speed mode are performed in accordance with the user operations.

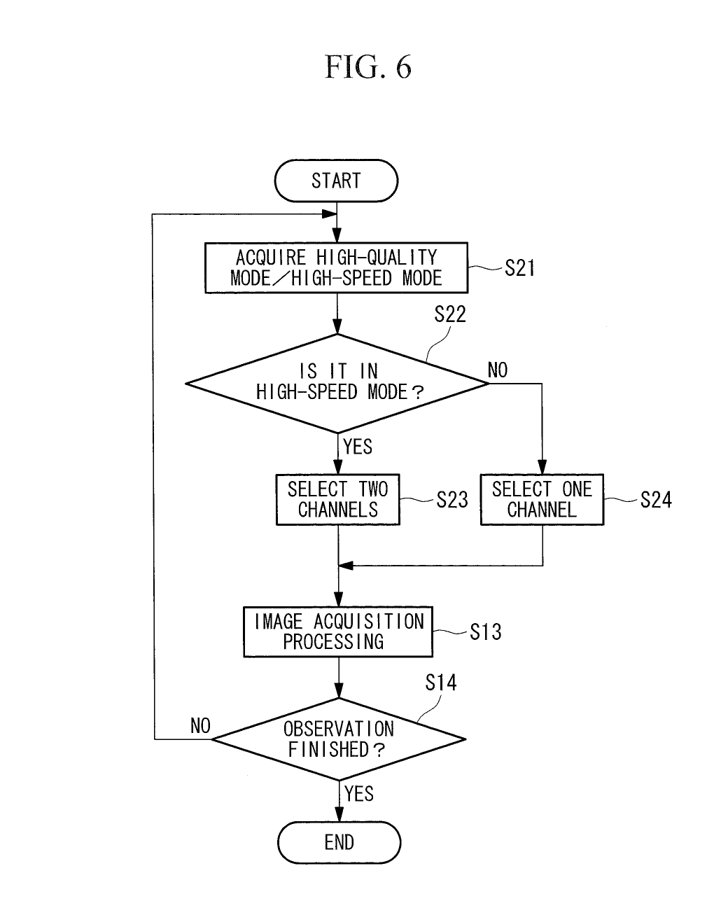

When the user selects framing or capturing of a still image, as shown in FIG. 6, the image acquisition apparatus 1 acquires mode information from the microscope controller 20 which indicates either the high-quality mode or the high-speed mode (Step S21), and judges whether or not the acquired mode is the high-speed mode (Step S22). If the mode is set to the high-speed mode, the two-channel image acquisition is selected (Step S23), and, if the mode is set to the high-quality mode, the one-channel image acquisition is selected (Step S24).

Note that, in the above description, the high-quality mode or the high-speed mode is set in accordance with framing or still image capture selected by the user; however, without being limited thereto, the high-quality mode or the high-speed mode may be set in accordance with the microscopy method.

Specifically, data associating the microscopy methods with the modes are stored in advance in the microscope controller 20 so as to set the high-quality mode or the high-speed mode in association with the respective microscopy methods. These data are such that, for example, the high-quality mode is set for fluorescence observation and the high-speed mode is set for bright-field observation.

Then, when the user selects a microscopy method via the touch screen, the high-quality mode or the high-speed mode stored in the microscope controller 20 is set in accordance with that selection.

It is needless to say that the user can arbitrarily switch between the high-quality mode and the high-speed mode via the touch screen.

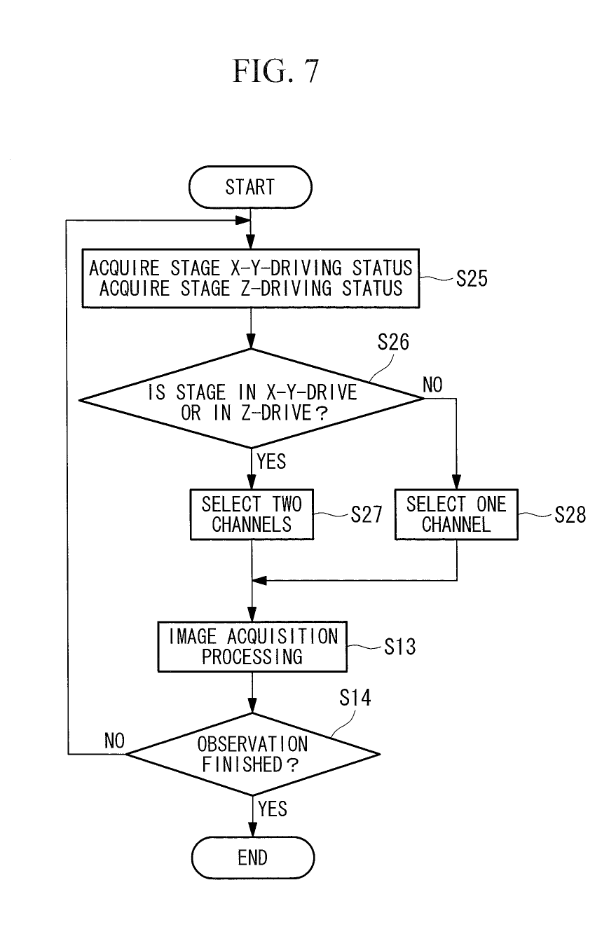

Next, a case in which the number of channels to be used is changed in accordance with the operation of the electric moving stage 23 will be described. As shown in FIG. 7, first, the computer 14 acquires the driving status of the electric moving stage 23 from the microscope controller 20 (Step S25), and it is judged whether or not the electric moving stage 23 is being driven (Step S26). Two-channel image acquisition is selected when the electric moving stage 23 is being driven (Step S27), and, one-channel image acquisition is selected when the electric moving stage 23 is not moved (Step S28).

By doing so, with a microscopy method in which differences between the channels are more likely to be conspicuous when an image is formed by combining image signals from a plurality of channels because the viewing field is dark and the gain tends to be large, as in the case of fluorescence observation or dark-field observation, one-channel image acquisition is performed. On the other hand, with a microscopy method in which the viewing field is bright and the exposure time is short, two-channel image acquisition is performed, thus enabling high-frame-rate image acquisition and high-quality image acquisition in accordance with the observation purpose.

In addition, two-channel image acquisition is performed while the electric moving stage 23 is moving due to the user operation and one-channel image acquisition is performed after driving of the electric moving stage 23 is completed, thus making it possible to enhance the operability of the electric moving stage 23 while referring to a framing image.

Note that, in this embodiment, although an imaging device 4 that is capable of two-channel parallel outputting has been described as an example, alternatively, an imaging device 4 that is capable of multi-channel parallel outputting involving three or more channels may be employed.

In addition, in the case of a manually-operated microscope, operating conditions may be acquired by providing an encoder in an operating portion.

In addition, regardless of whether the microscope is manually operated or electrically powered, the number of channels to be used may be changed based on various conditions of the optical systems, such as adjustment of the light levels from the light sources 21a and 22a, insertion and removal of the ND filter, switching of the objective lenses 24, and so forth.

In addition, instead of the touch-screen-based microscope controller 20, any other type of input portion, for example, a keyboard, a mouse, or the like, may be provided as the input portion.

In addition, although the timing generators 11 and 12 are separately provided in the respective channels, alternatively, a shared timing generator may be employed for the plurality of channels.

The following configurations of the image acquisition apparatus are derived from the embodiment described above.

A first derived aspect of the image acquisition apparatus is provided with an imaging device that can output acquired image signals from a plurality of output portions; a timing generator that drives the output portions of the imaging device; and a condition acquisition portion that acquires observation conditions. Based on the observation conditions acquired by the condition acquisition portion, the timing generator switches between parallel outputting of the image signals from the plurality of output portions of the imaging device and single outputting of the image signal from any one of the output portions.

With this aspect, when the timing generator selects outputting the image signals in parallel from the plurality of output portions based on the observation conditions acquired by the condition acquisition portion, it is possible to capture an image at a high frame rate, and thus, it is possible to clearly capture an image of a fast-moving imaging subject or a video image. In addition, when the timing generator selects outputting the image signal from a single output portion based on the observation conditions, it is possible to acquire a high-quality image by preventing level differences from occurring in an image due to differences in the signal levels among output portions.

In addition, in the above-described aspect, the condition acquisition portion may acquire image acquisition conditions.

By doing so, when the image acquisition conditions acquired by the condition acquisition portion, for example, exposure time, digital gain, ISO sensitivity, degree of edge enhancement processing, and so forth, satisfy conditions that make it possible to satisfactorily ensure the acquisition of a high-quality image, it is possible to perform high-frame-rate image capturing by outputting the image signals in parallel from the plurality of output portions. In contrast, when the image acquisition conditions are not as described above, it is possible to acquire a high-quality image by outputting the image signal from a single output portion.

In addition, in a second derived aspect of the image acquisition apparatus is provided with a microscope main unit that acquires an optical image of a specimen; and the above-described image acquisition apparatus that captures the optical image acquired by the microscope main unit, wherein the condition acquisition portion acquires a setting of the microscope main unit.

With this aspect, when the settings of the microscope main unit acquired by the condition acquisition portion, for example, whether or not it is set to the high-speed mode, whether or not the stage is moving, and so forth, satisfy conditions that make it possible to satisfactorily ensure the acquisition of a high-quality image, it is possible to perform high-frame-rate image capturing by outputting the image signals in parallel from the plurality of output portions. In contrast, when the settings of the microscope main unit are not as described above, it is possible to acquire a high-quality image by outputting the image signal from a single output portion.

With the above-described individual aspects of the image acquisition apparatus, an advantage in which a high-quality image can be obtained by preventing level differences from occurring in an image when there are differences among signals output from a plurality of channels and in which an image can be obtained at a high frame rate when there is no or little difference among the signals is achieved.

### {Reference Signs List}

A specimen
1 image acquisition apparatus
2 microscope system
3 microscope main unit
4 imaging device
11, 12 timing generator
15 system control portion (condition acquisition portion)

1. An image acquisition apparatus comprising:
an imaging device that can output acquired image signals from a plurality of output portions;
a timing generator that drives the output portions of the imaging device; and
a condition acquisition portion that acquires observation conditions,
wherein, the timing generator is configured to switch between parallel outputting of the image signals from the plurality of output portions of the imaging device and single outputting of the image signal from any one of the output portions based on the observation conditions acquired by the condition acquisition portion.

2. The image acquisition apparatus according to claim 1, wherein the condition acquisition portion acquires image acquisition conditions.

3. A microscope system comprising:
a microscope main unit that acquires an optical image of a specimen; and
an image acquisition apparatus according to claim 1 that captures the optical image acquired by the microscope main unit,
wherein the condition acquisition portion acquires a setting of the microscope main unit.
